(19) United States
(12) Patent Application Publication
(10) Pub. No.: US 2016/0199889 A1
(43) Pub. Date: Jul. 14, 2016

(54) PROCESS POSITIONING AND PROCESS CONTROL UNIT FOR PROCESS CONTROL OF A WASH-DOWN HOSE AND USES

(71) Applicant: J. HVIDTVED LARSEN A/S, Silkeborg (DK)

(72) Inventor: Hans LARSEN, Silkeborg (DK)

(21) Appl. No.: 14/916,389

(22) PCT Filed: Aug. 20, 2014
(86) PCT No.: PCT/DK2014/050247

§ 371 Date: Mar. 3, 2016

(30) Foreign Application Priority Data
Sep. 9, 2013 (DK) PA 2013 00510
Oct. 8, 2013 (DK) PA 2013 00571

(51) Int. Cl. B08B 9/032; B08B 9/049; E03F 7/10; B65H 75/44; B65H 75/42

(52) U.S. Cl. CPC B08B 9/0325; B65H 75/4484; B65H 75/425; B65H 75/4407; B65H 75/4463; E03F 7/106; B08B 9/0495; B65H 2701/33

(57) ABSTRACT

The invention includes a process positioning and process control unit for process control of a wash-down hose having flushing nozzle for cleaning of waste-water pipes in which the wash-down hose is mounted on a cylindrical wash-down hose drum with an axial length. The unit includes a pulse emitter designed for emitting a fixed number of electrical pulses per rotation of the wash-down hose drum, a rotation direction indicator designed for determination of a rotational direction for the wash-down hose drum and a memory unit is designed with an address for storing data related to the electrical pulses from the pulse emitter and from the rotational direction indicator for determination of the rotational position of the wash-down hose drum where the storing of data is maintained independently from power supply to the memory unit.

### CROSS-REFERENCE TO RELATED APPLICATIONS

This application is a U.S. national state of International Appl. No. PCT/DK2014/050247 filed 20 Aug. 2014, which claimed priority to Danish Appl. Nos. PA 201 3 0051 0 filed 9 Sep. 2013 and PA 2013 00571 filed 8 Oct. 2013, which applications are incorporated herein by reference in their entireties.

### TECHNICAL FIELD

The invention relates to a process positioning and process control unit for process control of a wash-down hose with flushing nozzle for cleaning waste-water pipes in which the wash-down hose is mounted on a cylindrical wash-down hose drum.

The invention also relates to use of the process positioning and process control unit for determining a wash-down hose's roll out length in relation to cleaning of waste-water pipes.

The invention also relates to use of process positioning and the process control unit for determining a flushing nozzle's current speed in relation to cleaning of waste-water pipes.

The invention also relates to use of the process positioning and process control unit for regulating a flushing nozzle's current speed in relation to a predetermined movement speed of the flushing nozzle in connection with cleaning of waste-water pipes.

Moreover, the invention relates to use of the process positioning and process control unit for full or partial automatic adjustment of a flushing process in connection with cleaning of waste-water pipes.

### BACKGROUND

Cleaning of waste-water pipes will traditionally be carried out with mobile device, which has mounted a suction device for filth and a powerful high pressure rinsing pump connected to a wash-down hose drum, which can rotate and thereby store, roll out and roll up a specific number of meters of wash-down hose.

In the outermost end of the wash-down hose, there is mounted a flushing nozzle, for this purpose, the constructed flushing nozzle provided with a suitable number of holes with suitable diameter, mainly facing backwards.

The flushing process is subsequently initiated by putting the flushing nozzle down into the well and into the waste-water pipe, which is to be cleaned. Thereafter, the wash-down hose is put under pressure, such that the flushing water now with large force becomes pushed backwards through the nozzle holes. The reaction from these backwards facing water streams makes the nozzle pull itself forward and up through the pipe with the wash-down hose dragged behind itself. Since this first phase is primarily just a transport process, and not an actual cleaning process, this should occur with the lowest possible water consumption, meaning as fast as possible with the wash-down hose drum's transmission coupled in free running.

When the nozzle has reached the next well, the actual cleaning process starts by pulling the now unwilling flushing nozzle back home at an appropriately slow speed, still with a high water pressure, such that the waste-water pipe is left totally clean, and the filth becomes pulled along outwards and downwards through the pipe. In the lowest well, the filth is being sucked, during the whole wash-down process by use of the suction device, up in a tank.

If there is so much filth in the pipe that it can not be cleaned completely in a single process, the process can be repeated as needed.

During roll up on the wash-down hose drum, the wash-down hose should preferably be placed in such a way that the wash-down hose's roll up point is displaced, for each wash-down drum rotation, one wash-down hose diameter in axial direction until the end of the wash-down drum is reached and the hose layer is full, whereafter the displacement direction is changed and the next hose layer is applied from opposite side and in opposite direction. This process can be carried out manually, but since there are large forces involved, and also monotonous repeated tasks, there are significant advantages by automating the process.

The classic construction of a mechanical hose guide is based on a double cut worm gearing with cycling glide. The worm's rotation is operated directly from the drum rotation via a mechanical transmission with suited gear ratio and has thereby got a permanent mechanical memory. The cycling glide is joined mechanically with a set of leading rolls, which continuously carry out the hose's axial movement.

It has been found, however, that this known technique with such mechanical memory involves some drawbacks. The construction is thus heavy and it is also both vulnerable, maintenance demanding and is worn out quickly. This is exacerbated further by both sharp bent angles on the wash-down hose and the harsh high-pressure water and salt fog environment on the rear side of a sludge exhauster/flusher.

U.S. Pat. No. 5,636,648 describes a process positioning and process control unit for process control of a wash-down hose with flushing nozzle, which can be used for cleaning waste-water pipes. The wash-down hose is mounted on a cylindrical wash-down hose drum with an axial length, and where the wash-down hose drum has a rotational position.

### SUMMARY OF THE INVENTION

It is therefore an object of the invention to show a process positioning and process control unit for a wash-down hose without the above-mentioned drawbacks.

The object of the invention is achieved by a process positioning and process control unit for process control of a wash-down hose with flushing nozzle for cleaning of waste-water pipes in which the wash-down hose is mounted on a cylindrical wash-down hose drum with an axial length and where the wash-down hose drum has a rotational position, which is characterized in that the process positioning and process control unit includes a pulse emitter, a rotating direction indicator and a memory unit in which:
the pulse emitter is designed for emitting a fixed number of electric pulses per rotation of the wash-down hose drum.
the rotating direction indicator is designed for determining a rotating direction of the wash-down hose drum, and
the memory unit is designed with an address for storing data related to the electrical pulses from the pulse emitter and from the rotating direction indicator for determining the rotational position of the wash-down hose drum and where the storage of data is maintained independently from power supply to the memory unit and that the wash-down hose has a roll-out length indicated by the flushing nozzle's position and the memory unit additionally includes an address for storage of data related to the wash-down hose drum's dimension and the wash-down hose's dimension for determining the roll-out length by comparing the wash-down hose drum's rotational position and the wash-down hose drum's dimension and the wash-down hose's dimension.

With the process positioning and process control unit according to the invention, the wash-down hose drum is thus equipped with a pulse emitter, which emits a fixed number of electrical pulses per drum rotation. This electrical signal is used to give information about the drum's speed of rotation and position measured in for examples rotations per minute.

The process positioning and process control unit also includes, according to the invention, a rotating direction indicator for determining a rotational direction of the wash-down hose drum. Use of such a rotating direction indicator thus allows not only registration of the wash-down hose drum's speed of rotation but also its direction of rotation.

The memory unit is capable of registering electronically and storing the current flushing drum situation, regardless of power cuts, emergency stops or other interruptions of the working procedure such as lunch break or closing-time.

The process positioning and process control unit's memory unit has thus got a permanent electronic memory for the drum situation, for example by applying ““Reminent Data Memory”” in the specific unit. “Reminent Data Memory” is a special address in the memory unit, where there can continuously be written/overwritten. The last value, which has been written, will always appear again when the unit is turned on, also after a randomly long electrical cut.

With the process positioning and process control unit, according to the invention, a specific basis situation is defined for the wash-down hose drum from which the process positioning and process control unit, by use of the memory unit herein, is capable of continuously creating a permanent “pulse score”, where the current accumulated pulse number from the pulse emitter at any time will represent a specific position of the wash-down hose drum. When an obstacle is sometimes met at a sewer flushing, which can not be flushed, it is necessary to dig down to the specific pipeline.

When the obstacle has been found via flushing, it is a significant advantage if the flushing operator is capable of registering the distance from the flushing well out to the blocked obstacle, which is important information to the excavator operator. It is therefore advantageous to be able to determine the wash-down hose's roll-out length in relation to a reference point.

The electronic solution according to the invention allows a more accurate identification than the known technique, which uses measuring by use of a mechanical measurement wheel.

According to the invention, the determination of the wash-down hose's roll-out length is carried out on the basis of an algorithm. In practice, the wash-down hose's roll-up circumference will be changed in steps, which results in a relatively complicated algorithm. Alternatively, a simpler algorithm can be used, which is based on successive increase of the wash-down hose's roll-up circumference.

With the process positioning and process control unit, according to the invention, a well-functioning unit is thus achieved, where the process control of the wash-down hose occurs electronically and without the drawbacks, which mechanical memory function results in—or the drawbacks of conventional microprocessor technology where loaded data are reset in case of electrical cut.

In the context of this invention, the “wash-down hose drum's rotational position” is defined as the accumulated angle of the rotation of the wash-down hose drum, as a result of the total accumulated and direction rectified pulse number, meaning that the rotational position includes the total number of rotations+the angle in relation to a basis position.

According to another exemplary embodiment of the invention, the process positioning and process control unit can control a hose guide for positioning the wash-down hose in the wash-down hose drum's axial length on the basis of the stored data in the memory unit, such that there is continuously correspondence between the axial position of the wash-down hose and the rotational position of the wash-down hose drum.

The hose guide can thus be moved continuously, such that there is continuously correspondence between the axial position of the wash-down hose and the rotational position of the wash-down hose drum, which on the basis of the electronic memory allows a precise control of the wash-down hose and the drum.

According to another exemplary embodiment of the invention, the process positioning and process control unit can additionally include a hose guide, which is designed to include at least one guide roll for positioning of the wash-down hose in the wash-down hose drum's axial length, in which at least one guide roll is movable in axial direction and where its axial movement is carried out hydraulic by use of a hydraulic cylinder on the basis of the data stored in the memory unit, such that there is continuously correspondence between the axial position of the at least one guide roll and the rotational position of the wash-down hose drum.

With the hose guide, the axial movement is carried out by a hydraulic cylinder instead of using a solely mechanical construction. Such a hydraulic construction is both strong, robust and does not require maintenance.

With the process positioning and process control unit, according to the above discussed exemplary embodiment of the invention, an additionally well-functioning unit is thus achieved where the process control of the wash-down hose occurs electronically and where energy supply and the force impact of wash-down hose and hose guide is hydraulic.

According to another exemplary embodiment of the present invention, the hose guide can additionally include an axial position measurer for determining the position of the at least one guide roll.

With such an axial position measurer, the current hose guide position, consisting of the guide roll's position, can be registered, and it can be determined if the position is consistent with the pulse score's desired hose guide position. The hose guide position can subsequently continuously be adjusted in accordance with it. The adjustment process is carried out by the hydraulic movement being activated via short electrical pulses to a on/off hydraulic valve, or a signal can alternatively be used, which operates an analogue hydraulic valve.

According to another exemplary embodiment of the present invention, the position measurer is preferably electronic, additionally preferably laser based or magnetic with high measurement accuracy.

The process positioning and process control unit, according to the invention, can also include a time determination function for determining the current speed with which the flushing nozzle is moved by comparison of the time determination function and the roll-out length.

When cleaning waste-water pipes with use of wash-down hose technology with rocket nozzle it is thus important that the optimum nozzle speed in the pipe is chosen. If the nozzle is pulled in too slowly, the water consumption becomes very high, and if the nozzle is pulled in too quickly, the flushing becomes inadequate.

Using knowledge of the wash-down hose drum's and the wash-down hose's dimensions, it is possible to continuously register, at any time, the calculated number of hose meters, which have been rolled up on the drum. By again combining this with a time function, the nozzle's immediate speed can continuously be registered and shown on a display.

If changes in the meter calculation are continuously combined with the electronic control unit's integrated time function, the current speed can continuously be calculated and shown. This output value of the current nozzle speed can continuously be monitored and from this it can be decided when and how much there should be compensated later.

It is also possible to fine compensate the nozzle speed calculation by using the wash-down hose's length changes originating from both the water pressure and the current pull force.

With this embodiment of the invention, an improved control is achieved of the nozzle speed in relation to a manual adjustment of it, for example by manual adjustment of the oil flow in a hydraulic valve or by remote control of the nozzle speed, which will vary with the flushing drum rotational speed and the roll-up degree.

It is also valuable that the correct speed parameter can easily and quickly be rediscovered when a similar task occurs at a later point in time.

It is additionally preferred that the process positioning and process control unit, according to the invention, can include an adjustment unit containing data relating to a predetermined movement speed of the flushing nozzle for adjustment of the current speed by which the flushing nozzle is moved in relation to the predetermined movement speed of the flushing nozzle.

If one has thus programmed the desired nozzle speed in the process positioning and process control unit's memory unit, the unit will continuously be able to compare the current nozzle speed to the desired nozzle speed and thereby constantly adjust a regulatory change of the speed signal to the wash-down hose drum, such that the nozzle's speed for example can be held constant during the whole pull.

The process positioning and process control unit, according to the invention, can in the memory unit have stored one or more additional process parameters for a flushing process for full or partial automatic regulation of the flushing process.

Such process parameters can preferably include general process parameters from the group of process parameters including correlations between wash-down hose material, liquid flow and pressure in the wash-down hose, connections between flushing nozzle sizes and shapes, and flushing and vacuum pump displacement and exchange.

Additional or alternatively, the process parameters can include individual process parameters from specific wells from the group of process parameters including well depth and well diameter and the waste-water pipe's material, diameter, length, drop and degree and character of being dirty and flow of water.

By this preferred embodiment of the invention, it is made possible to eliminate the variation in changing operators' estimates of which parameters that are best suited for a specific flushing task. You can thus pre-program the process positioning and process control unit with general data and/or individual data, specific for the concerned device and necessary information from the operator about the specific task and thereby make the unit to fully or partially take over control of the flushing process.

By thus also programming scientifically optimized connections between the flushing process's parameters and individual data specific of the concerned device, the operator's effort can be limited to defining and encoding characteristics, which are specific of the current job, such as the well's depth, the pipe's material, diameter, length, fall, degree and character of being dirty and flow of water.

Another aspect includes use of the process positioning and process control unit for positioning and controlling a wash-down hose in connection with cleaning of waste-water pipes.

A third aspect of the invention includes use of the process positioning and the process control unit according to the invention for determining a wash-down hose's roll out length in connection with cleaning of waste-water pipes.

A fourth aspect of the invention includes use of the process positioning and the process control unit according to the invention for determining a flushing nozzle's current speed in connection with cleaning of waste-water pipes.

A fifth aspect of the invention includes use of the process positioning and the process control unit according to the invention for adjusting a flushing nozzle's current speed in relation to a predetermined movement speed of the flushing nozzle in connection with cleaning of waste-water pipes.

A sixth aspect of the invention includes use of the process positioning and process control unit according to the invention for full or partial automatic adjustment of a flushing process in connection with cleaning of waste water pipes.

### BRIEF DESCRIPTION OF THE DRAWINGS

The invention will now be explained further with reference to the drawings, on which:

FIG. 1 shows the process positioning and process control unit according to the invention.

FIG. 2 shows known technology consisting of mechanical hose guide with double cut worm gearing.

FIG. 3 shows the hydraulic cylinder from the process positioning and process control unit according to the invention.

### DETAILED DESCRIPTION OF THE INVENTION

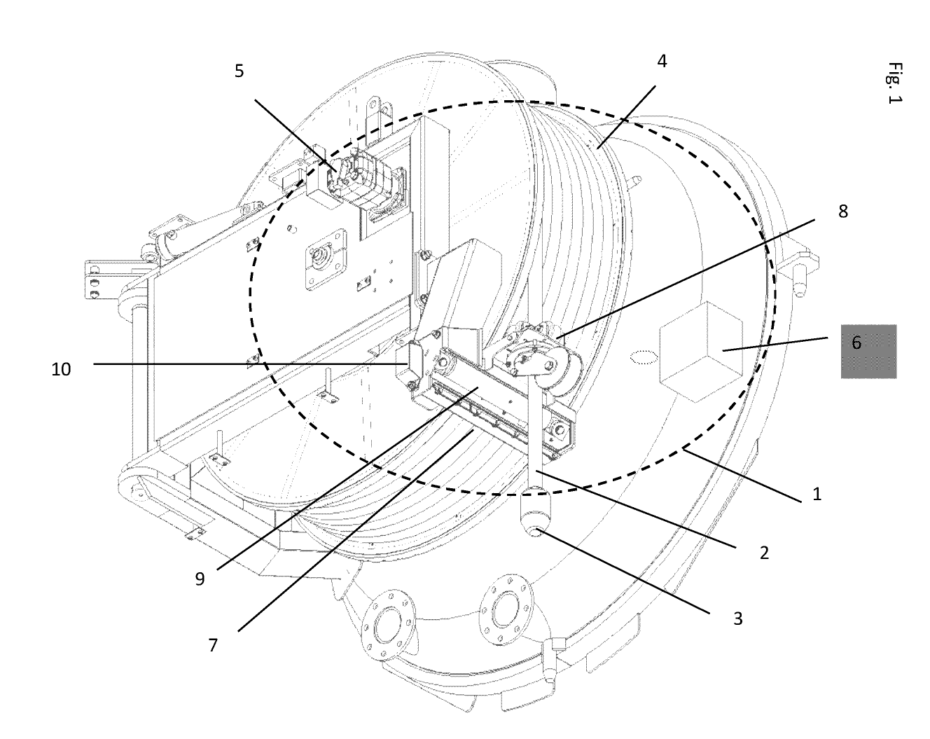

In FIG. 1 is with 1 shown the process positioning and process control unit according to the invention, including the pulse emitter 5, the rotation direction indicator 5a and the memory unit 6.

The pulse emitter 5 and the rotation direction indicator 5a, which are integrated with the pulse emitter 5, are mounted on the hose drum 4, which holds the wash-down hose 2 with the flushing nozzle 3.

The pulse emitter 5 emits electrical pulses per rotation of the wash-down hose drum 4 whose rotational direction is also determined by the rotation direction indicator 5a, and the resulting data is stored in the memory unit 6, which can control a hose guide 7 with a hydraulic cylinder 9, such that the wash-down hose 2 is continuously kept in the correct axial position of the guide roll 8. The guide roll's 8 position is monitored by the laser based position measurer 10.

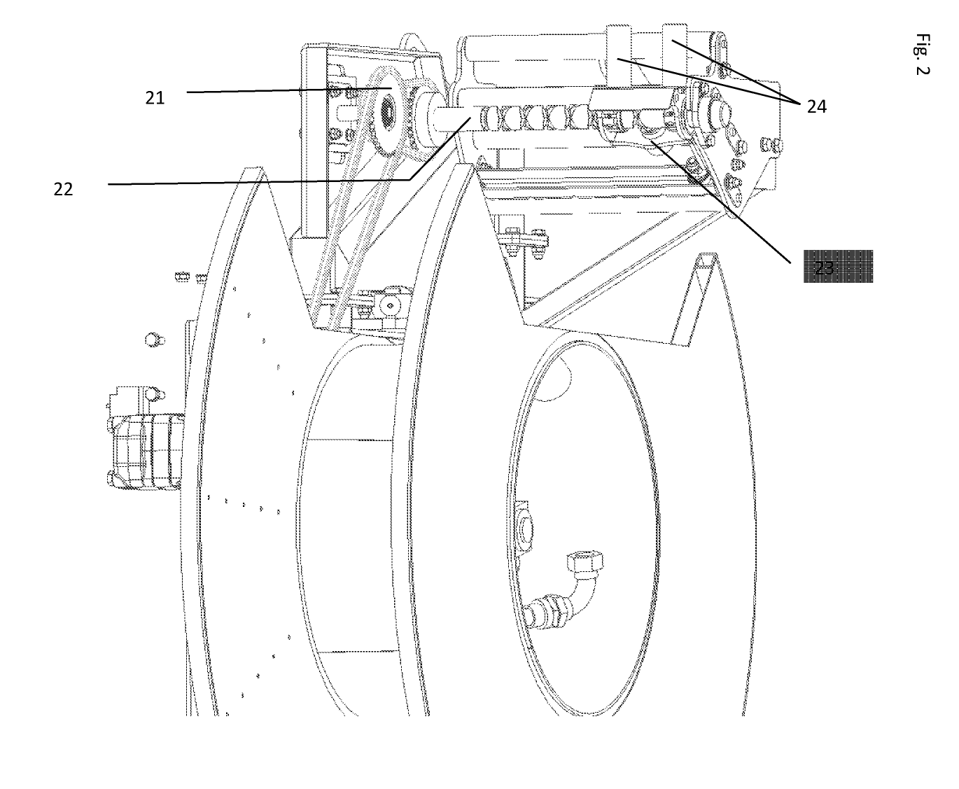

The known technology, consisting of a mechanical hose guide, shown in FIG. 2, includes mechanical transmission unit 21, which creates the correspondence between the hose drum and the double cut worm gearing 22, which via the cycling glide 23 and the guide rolls 24 create the mechanical positioning of a wash-down hose (not shown).

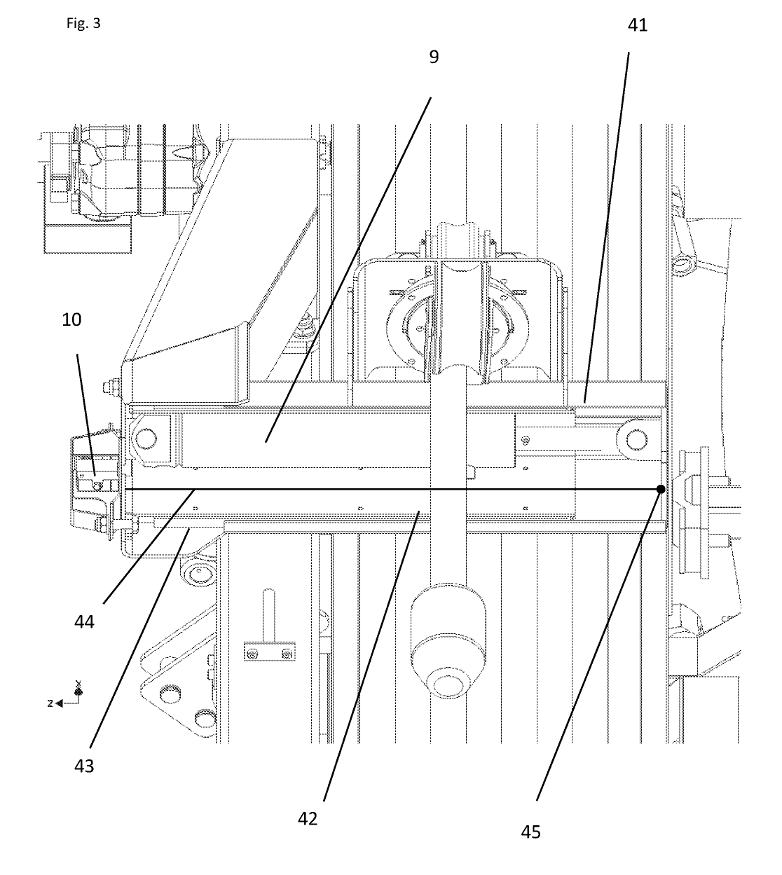

In FIG. 3 is shown the hydraulic cylinder 9 from the process positioning and process control unit 1 according to the invention. The cylinder includes an outer, displaceable telescopic pipe 41 and an inner, fixed telescopic pipe 42, which are movable in relation to each other and separated by a wearing intermediate layer of polypropylene plastic 43. The laser based position measurer 10 detects the position of the guide roll by application of the laser beam 44 with target point 45.

1-14. (canceled)

15. A process positioning and process control unit for process control of a wash-down hose having a flushing nozzle at the outermost end of the wash-down hose for cleaning waste-water pipes, wherein:
the wash-down hose is mounted on a cylindrical wash-down hose drum, wherein the wash-down hose drum has an axial length and rotated to thereby store, roll out and roll up a specific number of meters of the wash-down hose,
wherein when the wash-down hose is put under water pressure, the wash-down hose is rolled out and the flushing nozzle pulls itself forward and up through the waste-water pipe with the wash-down hose dragged behind the flushing nozzle,
wherein the wash-down hose is rolled up on the wash-down hose drum by pulling the still water-pressurised flushing nozzle back towards the wash-down hose drum, and
wherein the wash-down hose drum has a rotational position defined by the total number of rotations plus the rotated angle of the wash-down hose drum in relation to a basis position of the wash-down hose drum;
wherein the process positioning and process control unit comprises:
a pulse emitter, wherein the wash-down hose drum is equipped with the pulse emitter, and the pulse emitter is designed for emitting a fixed number of electrical pulses per rotation of the wash-down hose drum,
a rotating direction indicator configured for determining a rotation direction of the wash-down hose drum, and
a memory unit comprises a first address for storing data related to the electrical pulses from the pulse emitter and for storing data relating to the rotation direction the wash-down hose drum from the rotating direction indicator for determining the rotational position of the wash-down hose drum and a second address for storage of data related to the wash-down hose drum's dimension and the wash-down hose's dimension, wherein the storage of data is maintained independently from a power supply to the memory unit;
wherein the roll out length of the wash-down hose is given by the position of the flushing nozzle relative to the wash-down hose drum; and
wherein the roll out length of the wash-down hose is determined by an algorithm that compares the rotational position of the wash-down hose drum, the dimension of the wash-down hose drum and the dimension of the wash-down hose.

16. The process positioning and process control unit according to claim 15, wherein the process positioning and process control unit is configured to control a hose guide for positioning the wash-down hose in the wash-down hose drum's axial length on the basis of the stored data in the memory unit, such that there is continuously correspondence between the axial position of the wash-down hose and the rotational position of the wash-down hose drum.

17. The process positioning and process control unit according to claim 15, further comprising a hose guide configured to include at least one guide roll for positioning of the wash down hose in the wash-down hose drum's axial length, wherein the at least one guide roll is movable in axial direction and wherein axial movement of the at least one guide roll is carried out hydraulic by use of a hydraulic cylinder on the basis of the data stored in the memory unit, such that there is continuously correspondence between the axial position of the at least one guide roll and the rotational position of the wash-down hose drum.

18. The process positioning and process control unit according to claim 17, wherein the hose guide comprises an axial position measurer for determination of the position of the at least one guide roll.

19. The process positioning and process control unit according to claim 18, wherein the position measurer is electronic, preferably laser based or magnetic.

20. The process positioning and process control unit according to claim 15, wherein the memory unit further comprises a time determination function for determining the current speed at which the flushing nozzle is moved by comparing the time determination function and the roll-out length.

21. The process positioning and process control unit according to claim 20, wherein the memory unit further comprises an adjustment unit containing data relating to a predetermined movement speed of the flushing nozzle for adjustment of the current speed by which the flushing nozzle is moved in relation to the predetermined movement speed of the flushing nozzle.

22. The process positioning and process control unit according to claim 21, wherein the memory unit further comprises additional process parameters for a flushing process for full or partial automatic adjustment of the flushing process.

23. The process positioning and process control unit according to claim 22, wherein the process parameters include general process parameters from the group of process parameters including connections between wash-down hose material, liquid flow and pressure in the wash-down hose, connections between flushing nozzle sizes and flushing nozzle shapes and flushing and vacuum pump displacement and exchange.

24. The process positioning and process control unit according to claim 22, wherein the process parameters include individual process parameters from specific wells from the group of process parameters including well depth and well diameter and the waste-water pipe's material, diameter, length, fall and degree and character of being filthy and flow of water.

25. Use of the process positioning and process control unit according to claim 15 for determining the wash-down hose's roll-out length in connection with cleaning of waste-water pipes.

26. Use of the process positioning and process control unit according to claim 20 for determination of the flushing nozzle's current speed in connection with cleaning of waste-water pipes.

27. Use of the process positioning and process control unit according to claim 21 for adjustment of the flushing nozzle's current speed in relation to a pre-determined movement speed of the flushing nozzle in connection with cleaning of waste-water pipes.

28. Use of the process positioning and process control unit according to claim 22 for full or partial automatic adjustment of a flushing process in connection with cleaning of waste-water pipes.

29. A method for positioning and controlling the position of a flushing nozzle at the outermost end of a water-pressurised wash-down hose when cleaning waste-water pipes, wherein:
when the wash-down hose is put under water pressure, the wash-down hose is rolled out and the flushing nozzle pulls itself forward and up through the waste-water pipe with the wash-down hose dragged behind the flushing nozzle, and the wash-down hose is rolled up on the wash-down hose drum by pulling the still water-pressurised flushing nozzle back towards the wash-down hose drum,
the wash-down hose is mounted on a cylindrical wash-down hose drum, which wash-down hose drum has an axial length and rotates to thereby store, roll out and roll up a specific number of meters of wash-down hose, and
the wash-down hose drum has a rotational position defined by the total net number of rotations plus the rotated angle of the wash-down hose drum in relation to a basis position of the wash-down hose drum;
wherein the method comprises:
using a process positioning and process control unit comprising a pulse emitter provided on the wash-down drum, a rotating direction indicator and a memory unit configured to electronically registers and stores a current wash-down hose drum situation,
emitting, by the pulse emitter, a fixed number of electrical pulses per rotation of the wash-down hose drum,
determining, by the rotating direction indicator, a rotation direction of the wash-down hose drum,
storing, by the memory unit, in a first address of the memory unit data relating to the electrical pulses from the pulse emitter, and data from the rotating direction indicator about the rotation direction of the wash-down hose drum,
storing, by the memory unit, in a second address of the memory unit data relating to the axial length of the wash-down hose drum and the dimension of wash-down hose,
maintaining the storage of data independently from a power supply to the memory unit,
determining, by the memory unit, the rotational position of the wash-down hose drum from the stored data, and
determining the roll out length of the wash-down hose given by the position of the flushing nozzle to the wash-down hose drum by an algorithm that compares the rotational position of the wash-down hose drum, the dimension of the wash-down hose drum, and the dimension of the wash-down hose.
